(19) United States
(12) Patent Application Publication
(10) Pub. No.: US 2025/0386253 A1
(43) Pub. Date: Dec. 18, 2025

(54) ACCESS POINT MULTI-LINK DEVICE INFORMATION EXCHANGE PROCEDURES FOR SEAMLESS ROAMING IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/225,767

(22) Filed: Jun. 2, 2025

Related U.S. Application Data
(60) Provisional application No. 63/659,147, filed on Jun. 12, 2024.
(60) Provisional application No. 63/710,931, filed on Oct. 23, 2024.
(60) Provisional application No. 63/767,902, filed on Mar. 6, 2025.
(60) Provisional application No. 63/790,320, filed on Apr. 17, 2025.

(51) Int. Cl. H04W 36/00; H04W 36/18; H04W 84/12

(52) U.S. Cl. CPC H04W 36/0061; H04W 36/0033; H04W 36/0069; H04W 36/18; H04W 84/12

(57) ABSTRACT

In an embodiment, a station (STA) may transmit a probe request message to a current AP associated with the STA in order to obtain neighboring AP information, including operating channel information for one or more neighboring APs. The current AP may communicate with the one or more neighboring APs to obtain the neighbor AP information. The current AP may provide STA with the neighboring AP information such that once the STA determines a need to perform a roaming from the current AP to a neighboring AP, the STA can successfully roam to the neighboring AP as the neighboring AP is prepared and able to accommodate the STA's roaming request.

### CROSS-REFERENCE TO RELATED APPLICATIONS

This application claims the benefit of priority from U.S. Provisional Application No. 63/659,147 entitled “SCANNING PROCEDURES FOR NEXT GENERATION WLANS” filed Jun. 12, 2024; U.S. Provisional Application No. 63/710,931, entitled “SCANNING PROCEDURES FOR NEXT GENERATION WLANS” filed Oct. 23, 2024; U.S. Provisional Application No. 63/767,902, entitled “SCANNING PROCEDURES FOR NEXT GENERATION WLANS” filed Mar. 6, 2025; and U.S. Provisional Application No. 63/790,320, entitled “SCANNING PROCEDURES FOR NEXT GENERATION WLANS” filed Apr. 17, 2025, all of which are incorporated herein by reference in their entireties.

### TECHNICAL FIELD

This disclosure relates generally to a wireless communication system, and more particularly to, for example, but not limited to, a station using an established access point to obtain neighboring access point information for roaming in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising: a memory; and a processor coupled to the memory. The processor is configured to transmit, to a first access point (AP) associated with the STA, a first frame including a request for information on one or more second APs that are not associated with the STA. The processor is configured to receive, from the first AP, a second frame that includes the information on the one or more second APs.

In some embodiments, the first frame is a basic service set (BSS) transition management query frame that requests the information on the one or more second APs that are neighbor APs of the first AP.

In some embodiments, the first frame is a basic service set (BSS) transition management query frame that requests a recommendation for a candidate AP among the one or more second APs.

In some embodiments, the processor is further configured to perform roaming from the first AP to a second AP based on the information on the one or more second APs.

In some embodiments, the first frame includes a request for (i) information identifying the one or more second APs, or (ii) information indicating whether context established between the STA and the first AP is transferrable to the one or more second APs.

In some embodiments, the second frame includes load information or queue length information for one or more access categories of the one or more second APs.

In some embodiments, the second frame includes a plurality of information elements, each information element being associated with a respective one of the one or more second APs.

In some embodiments, the first frame is a multi-link probe request frame that indicates a request for information on the one or more second APs that are neighbor APs of the first AP or belong to a seamless mobility domain (SMD); and the second frame is a multi-link probe response frame that includes the information on the one or more second APs.

In some embodiments, the multi-link probe request frame includes an SMD identifier that identifies the SMD to which the one or more second APs belong.

One aspect of the present disclosure provides a first access point (AP) in a wireless network, the AP comprising: a memory; and a processor coupled to the memory. The processor is configured to receive, from a station (STA) associated with the first AP, a first frame including a request for information on one or more second APs that are not associated with the STA. The processor is configured to communicate, with the one or more second APs, to obtain the information on the one or more second APs. The processor is configure to transmit, to the STA, a second frame that includes the information on the one or more second APs.

In some embodiments, the first frame is a basic service set (BSS) transition management query frame that requests the information on the one or more second APs that are neighbor APs of the first AP.

In some embodiments, the first frame is a basic service set (BSS) transition management query frame that requests a recommendation for a candidate AP among the one or more second APs.

In some embodiments, the first frame includes a request for (i) information identifying the one or more second APs, or (ii) information indicating whether context established between the STA and the first AP is transferrable to the one or more second APs.

In some embodiments, the second frame includes load information or queue length information for one or more access categories of the one or more second APs.

In some embodiments, the second frame includes a plurality of information elements, each information element being associated with a respective one of the one or more second APs.

In some embodiments, the first frame is a multi-link probe request frame that indicates a request for information on the one or more second APs that are neighbor APs of the first AP or belong to a seamless mobility domain (SMD); and the second frame is a multi-link probe response frame that includes the information on the one or more second APs.

One aspect of the present disclosure provides a station (STA) in a wireless network, the STA comprising: a memory; and a processor coupled to the memory. The processor is configured to receive, from a first access point (AP), an unsolicited frame that includes the information on one or more second APs. The processor is configured to perform roaming based on the information on the one or more second APs

In some embodiments, the frame includes load information or queue length information for one or more access categories of the one or more second APs.

In some embodiments, the frame includes a plurality of information elements, each information element being associated with a respective one of the one or more second APs.

In some embodiments, each of the one or more second APs operates on a respective operating channel that is different from an operating channel used for communication between the STA and the first AP.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a flow chart of an example process of a probe request in accordance with an embodiment.

FIG. 6 illustrates a flow chart of an example process of a probe response in accordance with an embodiment.

FIG. 7 illustrates a flow chart of an example process for providing a probe response in accordance with an embodiment.

FIG. 8 illustrates an example timeline with a directed probe request in accordance with an embodiment.

FIG. 9 illustrates an example timeline with a wildcard probe request in accordance with an embodiment.

FIG. 10 illustrates an example timeline with a wildcard probe request and individual probe response messages in accordance with an embodiment.

FIG. 11 illustrates an example timeline using fast Basic Service Set (BSS) fast transition (FT) Action frames in accordance with an embodiment.

FIG. 12 illustrates an example timeline with a multi-link probe request and response frames in accordance with an embodiment.

FIG. 13 illustrates a timeline for probing assistance via an assisting AP in accordance with an embodiment.

FIG. 14 illustrates a location aware Over the Distribution System (OTD) probing in accordance with an embodiment.

FIG. 15 illustrates a location unaware OTD probing in accordance with an embodiment.

FIG. 16 illustrates an example of received signal strength indicator (RSSI) measurement in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter.

As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

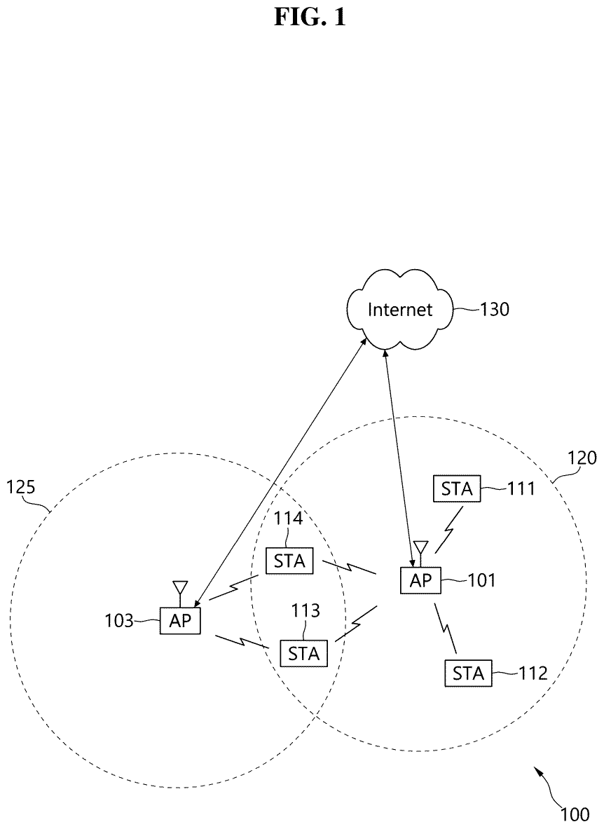

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

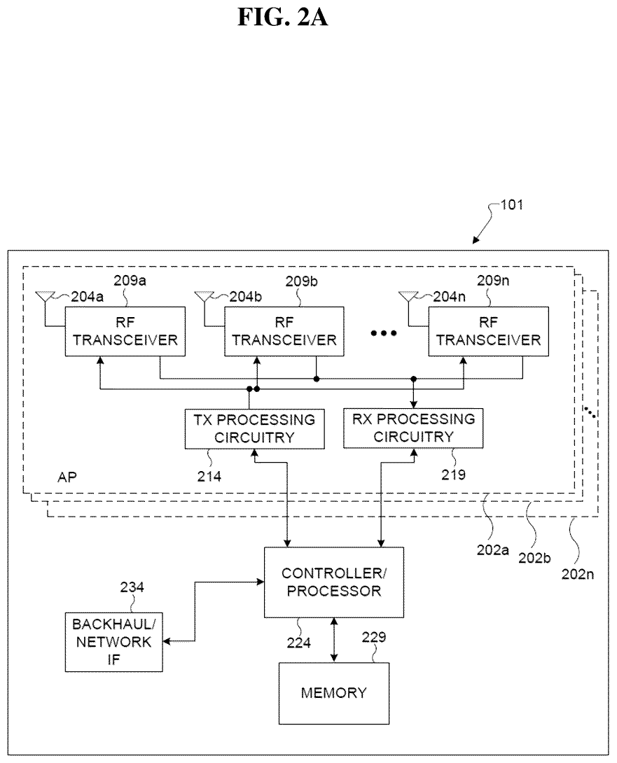

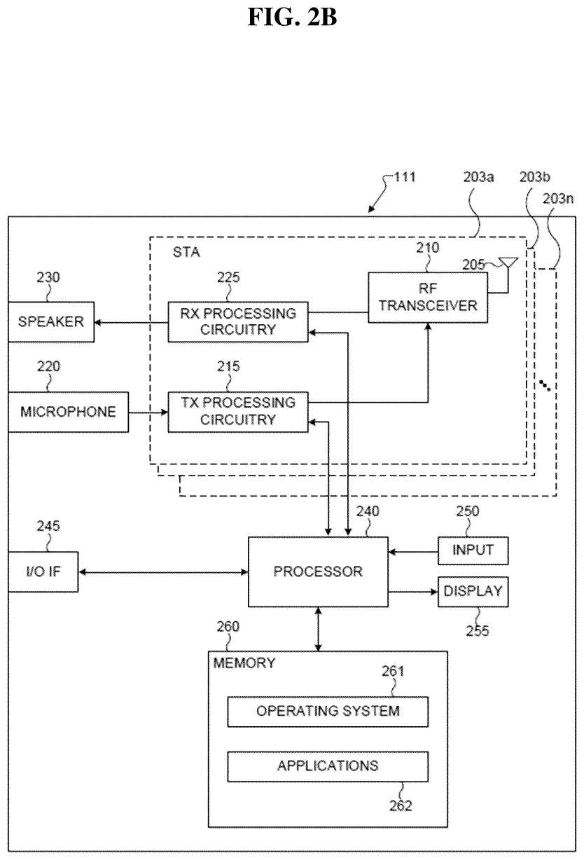

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

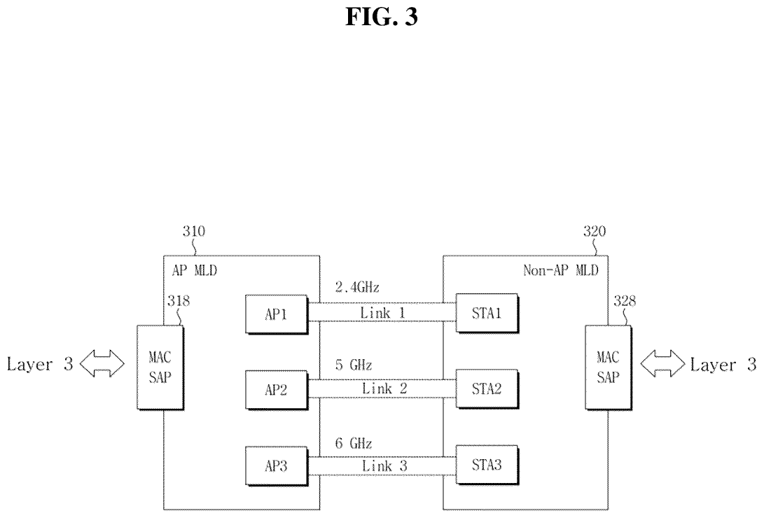

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

As users move around an environment while holding a STA device, a signal strength of the STA to its connected AP can vary. If a user's movement causes a significant decrease in a signal strength, a handover may be necessary. During the handover process, a STA may switch from an associated AP, which may be referred to herein as current AP (CAP), to a new AP.

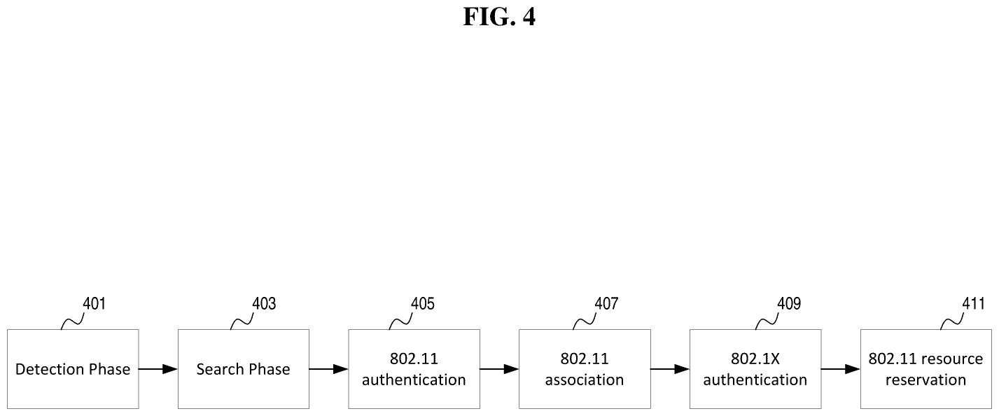

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and an 802.11 resource reservation phase 411.

During the detection phase 401, a STA may determine that there is a need for a handover. The procedures to detect a need for handover may be vendor specific. For instance, a particular vendor implementation may choose to trigger a handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively (e.g., listening to beacons on a particular channel) or actively (e.g., by the use of probe request and response procedure).

After the scanning procedure is complete, the next step is to perform 802.11 authentication (open system or shared key based) 405. Once the STA is authenticated, the next step is to perform 802.11 association 807. Introduced in IEEE 802.11i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform quality of service (QoS) reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove or reduce the delay encountered in various steps of the handover procedure. In 2008, IEEE 802.11r introduced a fast transition roaming which may eliminate the need for the authentication step (e.g., 802.11 authentication 405 in FIG. 4) during the handover. In 2011, IEEE 802.11k introduced assisted roaming which may reduce the search phase (e.g., search phase 403 in FIG. 4) by allowing the STA to request the AP to send channel information of candidate neighbor APs. In 2011, IEEE 802.11v also introduced network assisted roaming to assist the search phase. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of multi-link operation (MLO). This procedure helps to reduce the delays encountered due to IEE 802.11 resource reservation (e.g., 802.11 resource reservation 411 in FIG. 4).

In next generation wireless network, a number of APs can coordinate with each other to form a seamless mobility domain. With a seamless mobility domain, roaming from one AP to another AP can be done seamlessly by a STA (e.g., without requiring (Re)association). In some embodiments, the STA may indicate to the STA's current AP the candidate APs that the STA may intend to roam to. The current AP may then coordinate with the candidate APs to ensure a seamless roam for the STA (e.g., preparing potential neighbor or target AP(s) for the roam). In particular, when the STA detects a need to roam, the STA can inform the current AP about which neighbor AP the STA intends to roam to and the current AP may communicate with the one or more neighbor APs to determine whether the neighbor APs are available for roaming and provide a response message to the STA, upon which the STA may roam to a neighbor AP that is available for roaming.

Currently, when a STA needs neighbor AP information, it can perform scanning. The information that may be needed may be implementation specific and may be specified by the STA in a request to the neighbor AP. When performing active scanning, the STA may need to switch to other channel(s) to search for APs operating on those channels. When such a switch occurs, there can be a disruption in packet transmissions and receptions that may degrade the performance of one or more applications since the STA may be unable to receive frames as it is not on the same channel as the current AP. Accordingly, embodiments in accordance with this disclosure provide enhanced scanning procedures that minimize the need for the STA to perform such switching, providing for improved performance and user experience.

Furthermore, even when the information or channel of the neighbor AP is known, the STA may need to switch to the neighbor AP channel to perform one or more measurements, including measuring a Received Signal Strength Indicator (RSSI) value among other values. As described above, during such switching, there can again be some disruption in service. Accordingly, embodiments in accordance with this disclosure may minimize a measurement time of a STA in order to reduce the time during which a STA needs to go off channel to perform such measurements.

In some embodiments, the STA can transmit a request message to its current AP. In some embodiments, the request message may be a probe request message. The probe request message may be transmitted on the same channel as the current AP. The probe request message may request that the current AP obtain various neighbor AP information, including identifying information of neighboring APs within the vicinity of the STA and/or AP, operating channel information of the neighboring APs, context transferability information of the neighboring APs, among other information. In some embodiments, the neighbor AP information may include information that would otherwise be obtained by STA had the STA performed active scanning, whereby the STA may switch from an established channel between the STA and a current AP to different channels to search for and identify neighboring APs operating on those channels. Accordingly, the probe request message my request the AP to perform functions that may minimize a need of the STA to perform active scanning in order to obtain the neighbor AP information.

In some embodiments, the STA may request the AP to obtain neighbor AP information including information on a transferability of contexts or agreements, which may include information of transferability of one or more agreements (e.g., target wake time (TWT) agreement among others) or contexts, from the current AP to one or more neighbor APs. In some embodiments, context transfer may allow a STA to seamlessly switch from a current AP to a different AP during roaming and without having to again (re) establish one or more agreements or context with the different AP as those contexts or agreements would be transferred from the current AP to the different AP. In some embodiments, the probe request message may include at least one or more of the information items as indicated in Table 1.

Table 1 provides information items that may be included in a probe request message in accordance with an embodiment.

TABLE 1

| Information | |
|---|---|
| items | Description |
| Tunneled | One or more information item(s) that can indicate that the STA's intent to |
| probe request | request the current AP to tunnel the probe request message to one or more |
| intent/ | specified or unspecified APs. e.g., an identifier associated with the frame |
| Neighbor AP | that can make the indication, a field (e.g., bit or flag) that takes a |
| information | predetermined value to make the indication, a reason code, among others. |
| request | In some embodiments, the information item may be an indication to the |
| indication | current AP to gather information (by various means possible in |
| | implementation) on the neighboring APs. e.g., this can be a field (e.g., a bit |
| | or flag) that can take a predetermined value to make the indication, |
| | indication of the response message frame, among others. The information |
| | that may be gathered from the one or more neighboring APs may include |
| | identification information of one or more neighboring APs, operating |
| | channel information of one or more neighboring APs, context transferability |
| | information, among other information. |
| AP indication | One or more information item(s) that can indicate the AP(s) that the STA |
| | may want the current AP to probe. e.g., service set identifier (SSID), AP's |
| | basic service set identifiers (BSSID(s)), mobility domain, among others. |
| Context | One or more information item(s) that can indicate if the current context (e.g., |
| transfer | block acknowledgement (BA), stream classification service (SCS), Quality |
| possibility | of Service (QoS), target wake time (TWT), among others) that the STA has |
| check | with the current AP can be transferred to the new AP or not. e.g., a bitmap |
| | where each bit's position can indicate a specific context and that particular |
| | bit being set to 1 indicates that the STA wants the AP to check if that specific |
| | context can be transferred to the neighbor AP or not, a field (e.g., bit or flag) |
| | that takes a predetermined value to make the indication, among others. |
| Acknowledgement | One or more information item(s) that can indicate if the STA wants the |
| (ACK) required | current AP to provide an ACK to its request message or not. e.g., a field |
| indication | (e.g., bit or flag) that takes a predetermined value to make the indication. |
| Time duration | One or more information item(s) that can indicate the time by which the |
| | STA wants the current AP to provide the probing neighbor AP information |
| | to the STA. e.g., a timestamp. If the current AP receives multiple probe |
| | request messages from a number of STAs, then the AP can use this |
| | information to perform prioritization. |
| Legacy probe | One or more information item(s) from the legacy probe request frame. |
| content | |

In some embodiments, a request message may be a newly defined frame or an existing frame defined in the standards (e.g., modified directed probe request, modified wildcard probe request, modified BSS Transition Management (BTM) query, among others). In some embodiments, a directed message may be directed to a particular AP or STA. In some embodiments, a wildcard message may be a message that is directed to any APs or STAs.

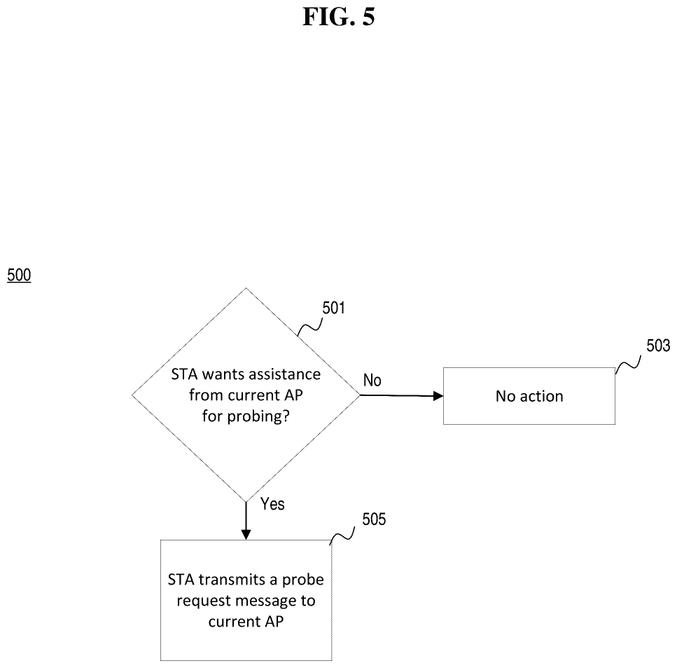

FIG. 5 illustrates a flow chart of an example process of a probe request in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 5 illustrates operations performed in a STA, such as the STA illustrated in FIG. 3.

The process 500, in operation 501, the STA determines whether the STA wants assistance from a current AP for probing one or more neighbor APs. If the STA determines that the STA does not want assistance from the current AP for probing, the process proceeds to operation 503 and the STA performs no action. If the STA determines that the STA wants assistance from the current AP for probing, the process proceeds to operation 503.

In operation 503, the STA transmits a probe request message to the current AP. In some embodiments, the probe request message may include one or more of the information items set forth in table 1, including a request to obtain information on one or more neighboring APs, including identification information of the neighboring APs, the operating channels of the neighboring APs or information regarding transferability of contexts to the neighboring APs. In particular, the probe request message may include an indication that the STA intends to request the current AP to tunnel the probe request message to one or more specified or unspecified APs. In some embodiments, tunneling may refer an AP communicating with one or more APs over a backhaul or wired network, where the APs may be affiliated or a part of a same seamless mobility domain (SMD). In some embodiments, the probe request message may include an information item that indicates one or more APs that the STA may want the current AP to probe for neighbor AP information. In some embodiments, the probe request message may include an indication regarding whether the STA wants the current AP to provide an acknowledgement (ACK) to the probe request message. In some embodiments, the probe request message may include an indication of a time by which the STA wants the current AP to provide the probing information.

In some embodiments, upon receiving a probe request message, the current AP can generate an acknowledgement (ACK) message and transmit the ACK message to the STA. The ACK message can include one or more of the information items as indicated in Table 2.

Table 2 provides information items that can be present in an ACK message in accordance with an embodiment.

TABLE 2

| Information | |
|---|---|
| item | Description |
| Receipt | One or more information item(s) that can indicate that the current AP has |
| notification | received the STA's request message. For example, a field (e.g., bit or flag) |
| | that takes a predetermined value to make the indication. |
| Current AP's | One or more information item(s) that can describe whether or not the current |
| response to | AP can perform the probing on behalf of the STA. For example, a field (e.g., |
| the request | bit or flag) that may take a predetermined value to make the indication, |
| | status code, among others. |
| AP indication | One or more information item(s) that can indicate the AP(s) that the current |
| | AP can probe. e.g., SSID, AP's BSSID(s), mobility domain, among others. |
| | In some embodiments, the indication can be a subset of the list that the STA |
| | has requested. |
| Time duration | One or more information item(s) that can indicate the time by which the |
| | current AP can complete the request made by the STA. This value can differ |
| | from the one requested by the STA based on AP or network side load, |
| | presence of higher priority operations, among others. |
| Reason | One or more information item(s) that can indicate the reason for the current |
| information | AP's response to the STA's probe request message. |

In some embodiments, an ACK message can be generated by the current AP on its own or upon request by the STA based on a response required indication included in a request message transmitted by the STA (e.g., indication provided in Table 1).

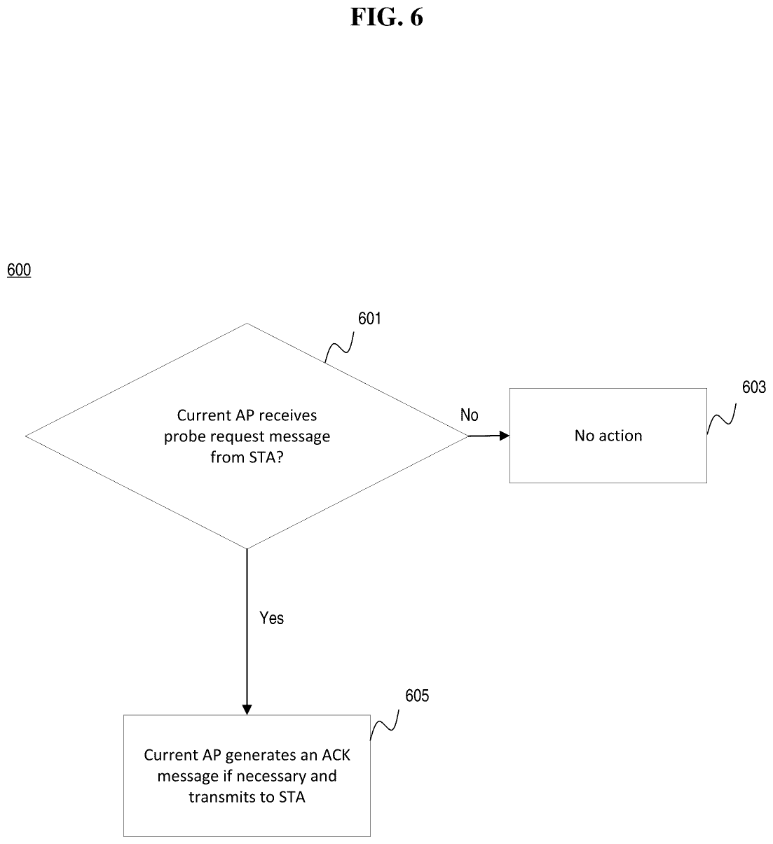

FIG. 6 illustrates a flow chart of an example process of a probe response in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed in a AP, such as the AP illustrated in FIG. 3.

The process 600, in operation 601, the current AP determines whether the current AP receives a probe request message from a STA. In some embodiments, the probe request message may request that the AP obtain information from one or more neighboring APs, where ethe information may include one or more of identification information, context transferability information, operating channel information, among various other types of information associated with the one or more neighboring APs. In some embodiments, the neighbor AP information may be used by the STA to perform roaming to the neighbor AP. If the current AP determines that the current AP does not receive a probe request message from the STA, the process proceeds to operation 603 and the AP performs no action. If the current AP determines that the current AP does receive a probe request message from the STA, the process proceeds to operation 605. In some embodiments the probe request message may include one or more of the information items provided in Table 1.

In operation 605, the current AP generates an ACK message, if necessary, and transmits the ACK to the STA. In some embodiments, the current AP may determine whether to generate and transmit an ACK message to the STA based on an indication in the probe request message that indicates whether or not the STA wants the current AP to provide an ACK to the request message. In some embodiments, the probe response message may be generated and transmitted by the current AP to a STA in an unsolicited manner.

In some embodiments, when the current AP can provide probing assistance to the STA, the current AP may either probe specified APs and/or neighbor APs and may provide the probe responses, beacons, or beacon content of those APs to the STA. In some embodiments, the AP may send a single message in which one or more (e.g., several or all) of the responses received from the neighboring APs can be included. In certain embodiments, the AP can generate several messages, and each message may include one or more responses from one or more neighboring APs to the STA.

In some embodiments, to obtain a neighboring AP information or content for a response, the current AP can tunnel the STA's probe request to indicated or neighbor APs and procure a response from them. In some embodiments, tunneling may refer to an AP communicating with one or more APs over a backhaul or wired network, where the APs may be affiliated or a part of a same seamless mobility domain (SMD). In some embodiments, the AP can obtain neighboring AP information for a response by gathering information about the indicated or neighbor APs by communicating with them using other means possible in implementation. In some embodiments, the AP may obtain neighboring AP information for a response using cached information, among various other mechanisms. In some embodiments, the AP may check for context transfer possibility with the indicated or neighbor APs. The current AP may share a current context setup between the STA and the current AP with a neighbor AP.

In some embodiments, when the current AP checks with a neighbor or target AP, the neighbor AP can provide a response message. In some embodiments, the response message may be a probe response message. In some embodiments, the neighbor AP may also provide a context transfer possibility based on the information shared by the current AP.

A probe response or response message from a current AP may include at least one or more of the information items as indicated in Table 3.

Table 3 provides information items that can be present in a probe response or response message in accordance with an embodiment.

TABLE 3

| Information | |
|---|---|
| items | Description |
| Probe response(s) | One or more information item(s) that can provide the probe response(s) |
| or Probe | or one or more information item(s) present therein. e.g., one or more |
| response(s) | example information items as indicated in Table 4 below. The indicated |
| contents | information items can be present in an existing or enhanced Reduced |
| | Neighbor Report (RNR) element. This RNR may be requested via the |
| | request message. |
| Responding AP | One or more information item(s) that can provide an indication of which |
| indication | APs have responded. |
| Pending AP | One or more information item(s) that can indicate which AP's responses |
| indication | are still pending. |
| Context transfer | One or more information item(s) that can indicate the neighbor AP(s) |
| response(s) | where context can be transferred to from the current AP and/or STA. |
| | This can either be an indication that one or more of the context currently |
| | setup with the current AP can be transferred to the neighbor APs or that |
| | one or more of the context currently setup can be transferred to the |
| | neighbor APs. In some embodiments, an indication regarding whether |
| | an individual context may be transferrable may be provided for each of |
| | one or more contexts. |
| Reason | One or more information item(s) that can indicate the reason for the |
| information | content of the current response message. e.g., a reason explaining why |
| | there are pending APs, among others. |
| Offset | One or more information item(s) that can indicate the offset of the |
| information | beacon of responding APs indicated in probe request message relative |
| | to the current AP. This can enable the STA to switch to the channels of |
| | those APs and minimize the wait time on the channels of those APs to |
| | procure the beacon. The offset information can also be provided in a |
| | separate message in an unsolicited manner or upon request. |
| Load | One or more information item(s) that can indicate the load information |
| information | of the indicated APs. e.g., total load, queue lengths for different access |
| | categories (ACs,) among others. |

Table 4 provides one or more information items that may be present in a probe request or probe response contents in accordance with an embodiment.

TABLE 4

| Information | |
|---|---|
| items | Description |
| AP indicators | One or more information item(s) that may include an identifier of the AP |
| | whose information can be reported. e.g., BSSID, SSID, AP MLD ID, |
| | among others. |
| Physical Layer | One or more information item(s) that can indicate the PHY related |
| (PHY) capability | capability of the reported AP. e.g., supported standard, security mode, |
| indicator | channel bandwidth, data rates, number of spatial streams, transmit power, |
| | among others. |
| Supported Media | One or more information item(s) that can indicate the supported MAC |
| Access Control | features. e.g., capability bits of different features being set to 1 to indicate |
| (MAC) features | support and to 0 to indicate missing support. |
| Operational | One or more information item(s) that can indicate the MAC features that |
| MAC features | are currently operational or turned off. e.g., AP's power save mode, among |
| | others. |

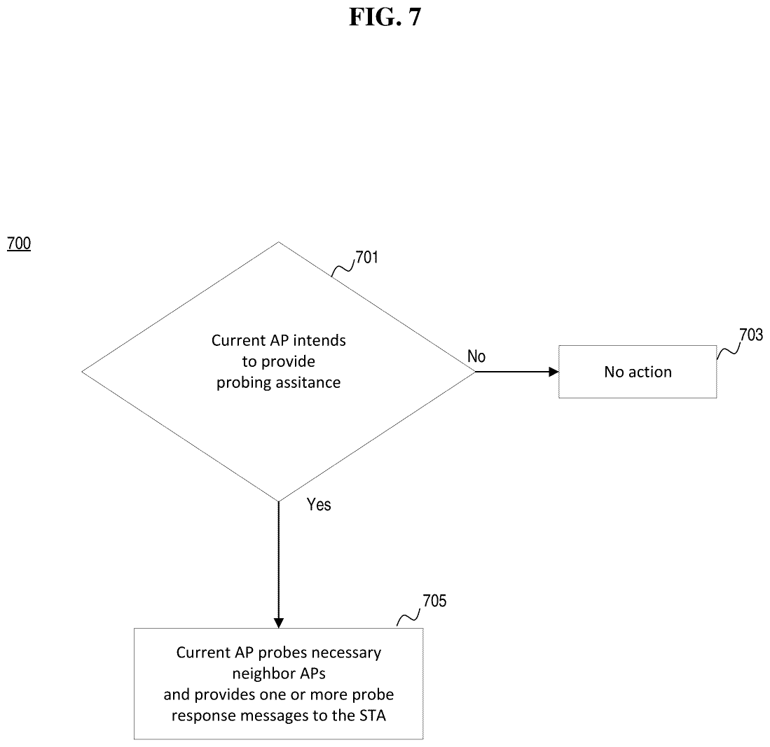

FIG. 7 illustrates a flow chart of an example process for providing a probe response in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed in a AP, such as the AP illustrated in FIG. 3.

The process 700, in operation 701, the current AP determines whether the current AP intends to provide probing assistance to one or more STAs. If the current AP determines that the current AP does not intend to provide probing assistance, then the process proceeds to operation 703 and the current AP performs no action. If the current AP determines that the current AP does intend to provide probing assistance, then the process proceeds to operation 705.

In operation 705, the current AP probes one or more necessary APs and provides one or more responses to the STA. In some embodiments, the current AP may tunnel a probe request message to one or more specified or unspecified APs. Tunneling may include the current AP communicating Over-the-Distribution System (DS), collectively (OTD), to other APs in the vicinity of the current AP. In some embodiments, tunneling over the OTD may include communicating over a wired network on a network backbone with other APs. In some embodiments, the AP may gather information from the distribution system (DS), where the DS may have information of one or more APs. In some embodiments, the current AP may gather information on the neighboring APs, including identification information, operating channel information, context transferability information, among others. In some embodiments, the current AP may have cached information on the neighboring APs. The current AP may provide one or more probe response message to the STA that may include the neighboring AP information. The probe response message may include one or more of the information items provided in Table 3 and/or Table 4. In particular, a probe response message may include an information item that provides one or more probe responses of Table 4. The probe response message may include a responding AP indication that provides an indication of which APs have responded to the current AP. The probe response message may include a pending AP indication that indicates which APs' responses are still pending. The probe response message may include a context transfer response that indicates the AP(s) where context may be transferred. The probe response message may include a reason information that indicates a reason for the content of the current response message (e.g., reason explaining why there are pending APs, among others). The probe response message may include offset information that indicates the offset of a beacon of responding APs indicated in the probe request message relative to the current AP.

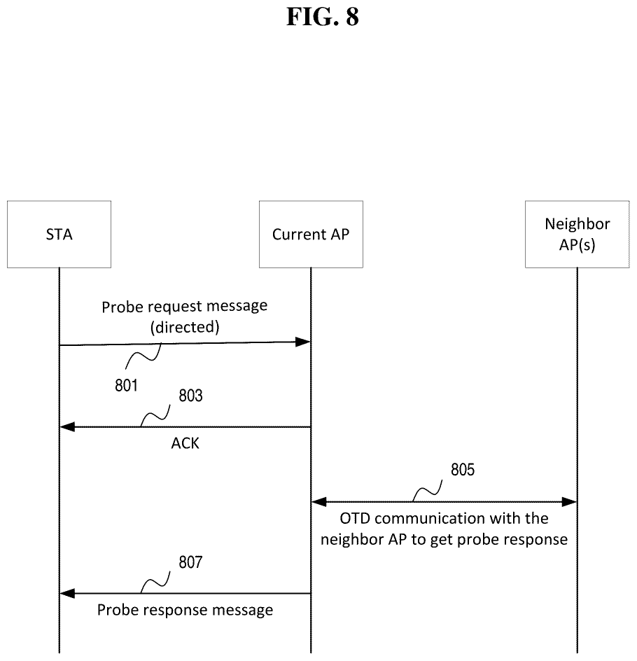

FIG. 8 illustrates an example timeline with a directed probe request in accordance with an embodiment. In particular, FIG. 8 illustrates communication among a STA, a current AP, and one or more neighbor APs. Initially, in operation 801, the STA transmits a probe request message (directed) to the current AP. As indicated, the probe request message may be a directed probe request message that may direct the current AP to communicate with one or more particular APs to obtain neighbor AP information. In some embodiments, the probe request message may include one or more of the information items in Table 1, including an indication that the STA intends to request the current AP to communicate the probe request message to one or more specified or unspecified APs. In some embodiments, the probe request message may include an information item that indicates one or more APs that the STA may want the current AP to probe to obtain neighbor AP information, including one or more of i) identification information of neighboring APs, ii) operating channel information of the neighboring APs, or iii) context transferability information of the neighboring APs, among others. In some embodiments, the probe request message may include an indication regarding whether the STA wants the current AP to provide an ACK to the probe request message. In some embodiments, the probe request message may include an indication of a time by which the STA wants the current AP to provide the probing information. Accordingly, in operation 803, the current AP transmits to the STA an ACK message in response to the probe request message. In operation 805, the current AP performs over-the-DS (OTD) communication with the one or more neighbor APs to gather the probe response information, including one or more of information identifying the neighbor APs, the operating channels of the neighbor APs, context transferability information, among others. In some embodiments, OTD communication may include communicating over a wired network on a network backbone among the current AP with other APs. In some embodiments, the AP may gather information from a distribution system (DS) affiliated with the AP, where the DS may have information of one or more APs.

In operation 807, the current AP transmits to the STA a probe response message that may include the neighbor AP information on the one or more neighbor APs. In particular, the probe response message may include one or more of the information items provided in Table 3 and/or Table 4, including a responding AP indication that provides an indication of which APs have responded to the current AP. The probe response message may include a pending AP indication that indicates which APs' responses are still pending. The probe response message may include a context transfer response that indicates the AP(s) where context may be transferred. The probe response message may include a reason information that indicates a reason for the content of the current response message (e.g., reason explaining why there are pending APs, among others). The probe response message may include offset information that indicates the offset of a beacon of responding APs indicated in the probe request message relative to the current AP.

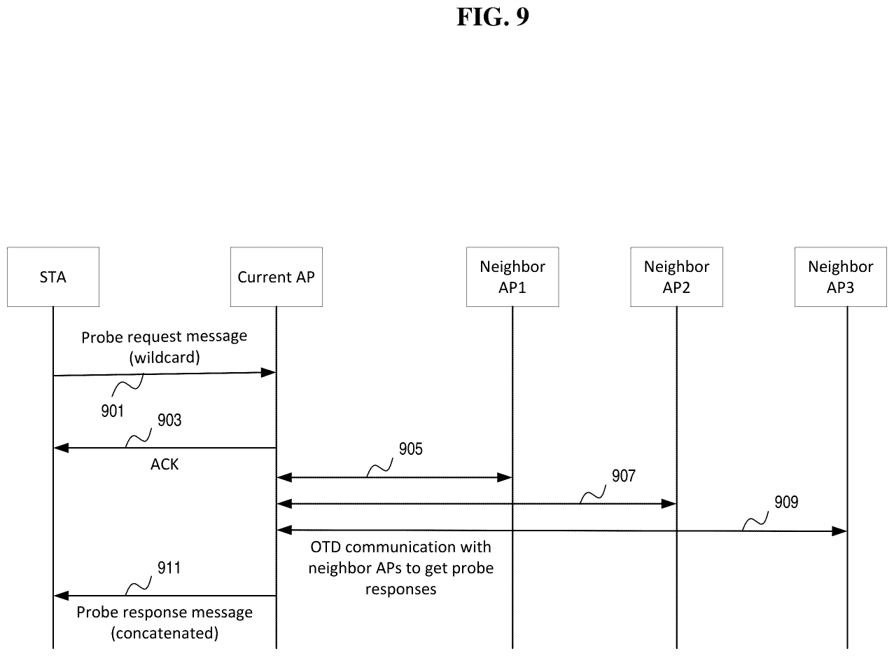

FIG. 9 illustrates an example timeline with a wildcard probe request in accordance with an embodiment. In particular, FIG. 9 illustrates communication among a STA, a current AP, a first neighbor AP1, a second neighbor AP2, and a third neighbor AP3. Initially, in operation 901, the STA transmits a probe request message (wildcard) to the current AP. As indicated, the probe request message may be a wildcard probe request message that may direct the current AP to communicate with any AP to obtain neighbor AP information. The probe request message may include one or more of the information items in Table 1, including an indication that the STA intends to request the current AP to communicate the probe request message to one or more specified or unspecified APs to obtain neighbor AP information. In some embodiments, the probe request message may include an information item that indicates one or more APs that the STA may want the current AP to probe to obtain neighbor AP information. In some embodiments, the probe request message may include an indication regarding whether the STA wants the current AP to provide an ACK to the probe request message. In some embodiments, the probe request message may include an indication of a time by which the STA wants the current AP to provide the probing information. Accordingly, in operation 903, the current AP transmits to the STA an ACK message in response to the probe request message. In operation 905, the current AP performs OTD communication with the neighbor AP1 to gather probe response information from AP1. In operation 907, the current AP performs OTD communication with neighbor AP2 to gather probe response information from AP2. In operation 909, the current AP performs OTD communication with neighbor AP3 to gather probe response information from AP3. In operation 911, the current AP transmits to the STA a probe response message (concatenated) that may include several messages with information from several neighboring APs that have been concatenated together where the messages may have been obtained during the OTD communication with the neighbor APs, including the neighbor AP1, neighbor AP2, and neighbor AP3. Accordingly, the probe response message may include several message concatenated together that have been received from several neighbor APs. In particular, the probe response message may include one or more of the information items provided in Table 3, including a responding AP indication that provides an indication of which APs have responded to the current AP. The probe response message may include a pending AP indication that indicates which APs' responses are still pending. The probe response message may include a context transfer response that indicates the AP(s) where context may be transferred. The probe response message may include a reason information that indicates a reason for the content of the current response message (e.g., reason explaining why there are pending APs, among others). The probe response message may include offset information that indicates the offset of a beacon of responding APs indicated in the probe request message relative to the current AP.

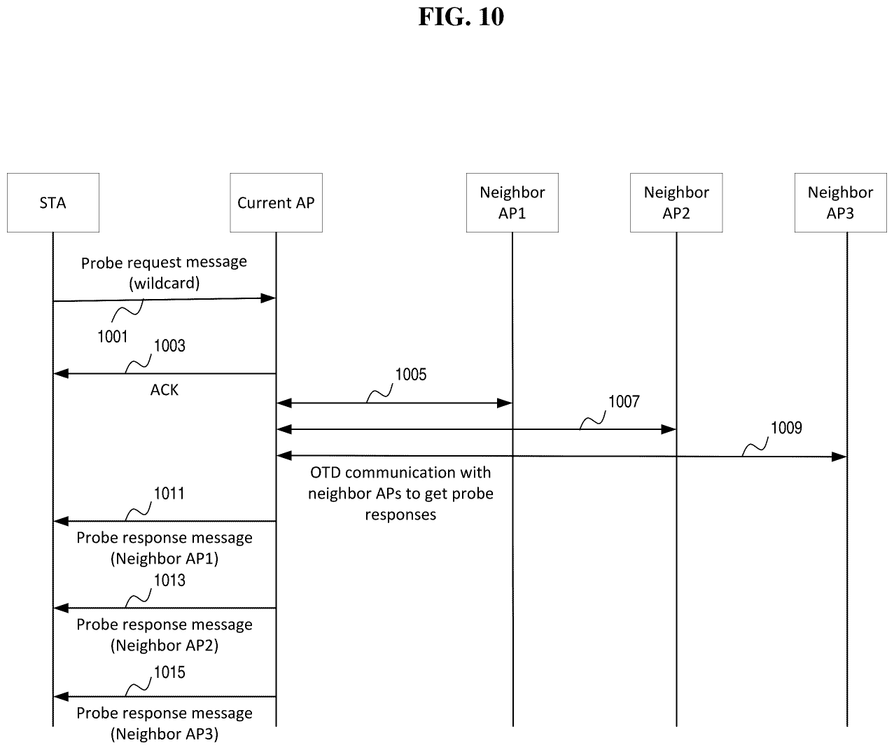

FIG. 10 illustrates an example timeline with a wildcard probe request and individual probe response messages in accordance with an embodiment. In particular, FIG. 10 illustrates communication among a STA, a current AP, a first neighbor AP1, a second neighbor AP2, and a third neighbor AP3. Initially, in operation 1001, the STA transmits a probe request message (wildcard) to the current AP. The probe request message may include one or more of the information items in Table 1, including an indication that the STA intends to request the current AP to communicate the probe request message to one or more specified or unspecified APs. In some embodiments, the probe request message may include an information item that indicates one or more APs that the STA may want the current AP to probe to obtain neighbor AP information. In some embodiments, the probe request message may include an indication regarding whether the STA wants the current AP to provide an ACK to the probe request message. In some embodiments, the probe request message may include an indication of a time by which the STA wants the current AP to provide the probing information. Accordingly, in operation 1003, the current AP transmits to the STA an ACK message in response to the probe request message.

In operation 1005, the current AP performs OTD communication with the neighbor AP1 to gather probe response information related to AP1. In operation 1007, the current AP performs OTD communication with neighbor AP2 to gather probe response information related to AP2. In operation 1009, the current AP performs OTD communication with neighbor AP3 to gather probe response information related to AP3. The probe response information from AP1, AP2 and AP3 may include identification information, operating channel information, or context transferability information, among other types of information. The current AP may transmit individual probe response messages to the STA for each responding AP. In some embodiments, the current AP may transmit the probe response messages as information is received from the different neighbor APs. In some embodiments, a probe response message may include information for a particular neighbor AP. In certain embodiments, a probe response message may include information for one or more neighbor APs for which information has been obtained. As illustrated, in operation 1011 the current AP transmits to the STA a probe response message (neighbor AP1) that may include the information on neighbor AP1. In operation 1013, the current AP transmits a probe response message (neighbor AP2) that may include information gathered on the neighbor AP2. In operation 1015, the current AP transmits a probe response message (neighbor AP3) that may include the information on the neighbor AP3. In some embodiments, the probe response messages may include one or more of the information items provided in Table 3.

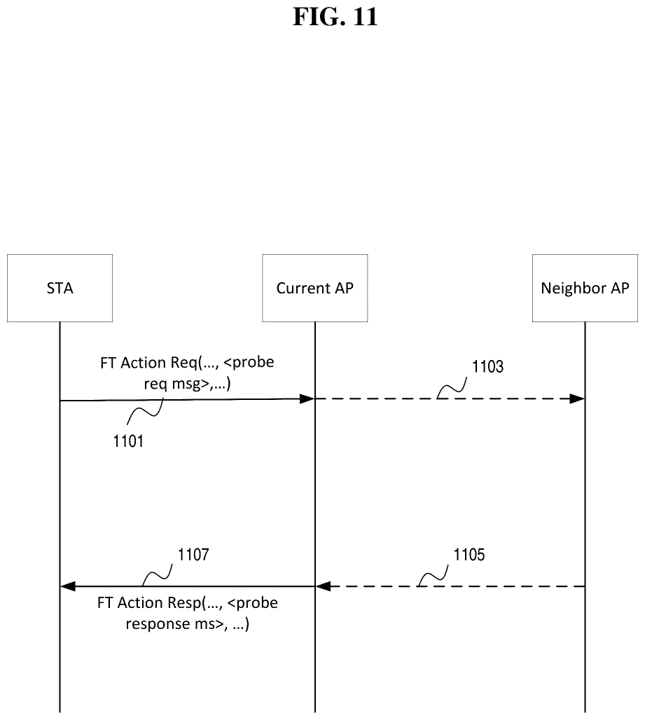

FIG. 11 illustrates an example timeline using fast BSS fast transition (FT) Action frames in accordance with an embodiment. In some embodiments, the STA may use FT Action frames to communicate with the current AP when initiating a fast roaming transition to a neighbor AP, particularly in over-the DS (OTD) fast transition (FT). In particular, FIG. 11 illustrates communication among anSTA, a current AP, and a neighbor AP. In operation 1101, the STA transmits to the current AP a FT Action Request frame (e.g., FT Action Req( . . . , <probe req msg>, . . . ) that indicates that the frame is a probe request message. Accordingly, in operation 1103, the current AP transmits an OTD request message to the neighbor AP to request probe response information. In operation 1105, the neighbor AP transmits an OTD response message to the current AP in response to the request message. Accordingly, in operation 1107, the current AP transmits to the STA a FT Action Response message (e.g., FT Action Resp( . . . , <probe response msg>, . . . ) that include the probe response information.

In some embodiments, a signaling may be performed via a multi-link (ML) probe request and response frames. In some embodiments, a STA may transmit a ML probe request frame to a first AP affiliated with an AP MLD to request information (e.g., complete or partial profile of the neighbor AP) of a second AP affiliated with a different AP MLD in the same mobility domain (e.g., FT mobility domain, SMD, among others). In some embodiments, a complete profile of a neighbor AP may include all of the elements or fields that may be included in a management frame of a same subtype as the management frame that includes the complete profile. In some embodiments, a partial profile may include a subset of the elements or fields that may be included in a management frame of a same subtype as the management frame that includes the partial profile. In some embodiments, the STA may request only a partial profile of the neighboring APs, such as identifying information. In certain embodiments, the STA may request a complete profile of neighboring APs, which may include a complete profile of the neighboring AP, including identifying information, operating channel information, and/or context transferability information, among other types of information that may be obtained.

In some embodiments, a ML probe request frame may be transmitted by a STA to the STA's current AP to gather information on a neighbor AP that can be a neighbor AP of the current AP in the SMD or FT mobility domain.

In some embodiments, APs affiliated with an AP MLD may use a same value in an AP MLD ID field when reporting the same non-collocated AP MLD. In some embodiments, non-collocated may refer to when an APs affiliated with an AP MLD are not in a same physical device as the AP MLD. In some embodiments, a non-collocated AP MLD (which may be referred to as a multi-AP MLD) may include an AP MLD, which includes a set of two or more APs, of which at least two APs are not co-located in the same physical device. In some embodiments, a same value in an AP MLD ID field may be used when two AP MLDs are a part of a same SMD or FT mobility domain.

In some embodiments, APs affiliated with different AP MLDs in an SMD or FT mobility domain may use a same value in an AP MLD ID field when reporting the same non-collocated AP MLD.

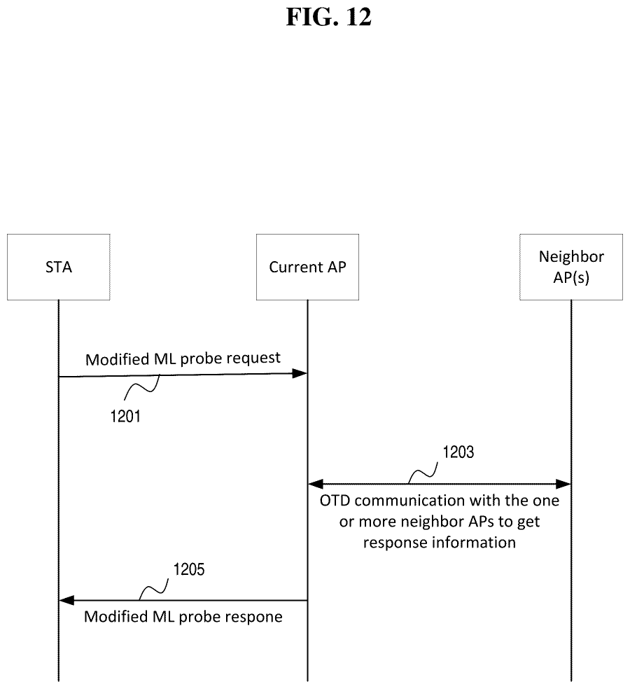

FIG. 12 illustrates an example timeline with a multi-link probe request and response frames in accordance with an embodiment. In particular, FIG. 12 illustrates communication among a STA, a current AP, and one or more neighbor APs. In operation 1201, the STA transmits to the current AP a modified ML probe request message. In operation 1203, the current AP performs OTD communication with the one or more neighbor APs to obtain response information. In operation 1205, the current AP transmits to the STA a modified ML probe response message.

In some embodiments, there can be a modified ML probe request message. A presence bitmap of the modified ML probe request message may carry one bit indication indicating that the non-AP MLD or STA intends to probe a neighbor AP MLD or AP. The AP MLD may be identified by the AP MLD ID subfield of the common info field of the modified ML probe request message.

In some embodiments, the ML probe request message may carry an SMD element to indicate the SMD to which the targeted AP MLD belongs to. The targeted AP MLD can be an AP MLD whose information is requested in the probe response frame transmitted in response to the probe request frame. The SMD element can include at least an SMD identifier which can indicate the SMD to which the targeted AP MLD belongs to.

In some embodiments, a non-AP MLD can include one or more per-STA profiles corresponding to APs affiliated with only one target AP MLD in the modified ML probe request message in the ML probe request frame.

In some embodiments, a non-AP MLD can include per-STA profiles corresponding to APs affiliated with more than on target AP MLD in the ML probe request message in the ML probe request frame.

In some embodiments, if an AP MLD receives a ML probe request frame that requests information for a particular targeted AP MLD and the receiving AP does not have information on the targeted AP MLD, then the receiving AP MLD can transmit a multi-link probe response frame that does not carry profile information. Receipt of such a ML probe response frame can indicate to the non-AP MLD that the transmitting AP MLD does not have information on the targeted AP MLD.

In some embodiments, it may be possible that the STA may lose its connection with the current AP and may need assistance from another AP. For example, the STA may go into sleep or power save mode and when the STA comes out of the sleep or power save mode, the RSSI to the STA's current AP may have dropped significantly. Thus, the STA may not be able to communicate with the STA's current AP. Accordingly, the STA may take probing assistance from another AP, which may be referred to as the assisting AP. In some embodiments, the STA may transmit a probe request message to the assisting AP (e.g., an AP in the same SSID, SMD, among others). In some embodiments, the STA may have performed a prior negotiation with one or more such assisting APs to seek assistance if needed. In some embodiments, when making a request for assistance through the assisting AP, the STA can also include the current AP's information (e.g., BSSID, among other information) in the probe request message. When the assisting AP receives such a request from the STA, then the assisting AP can first check various information with the current AP indicated by the STA. The current AP may verify the STA's identity. Accordingly, the assisting AP can then provide probing assistance to the STA.

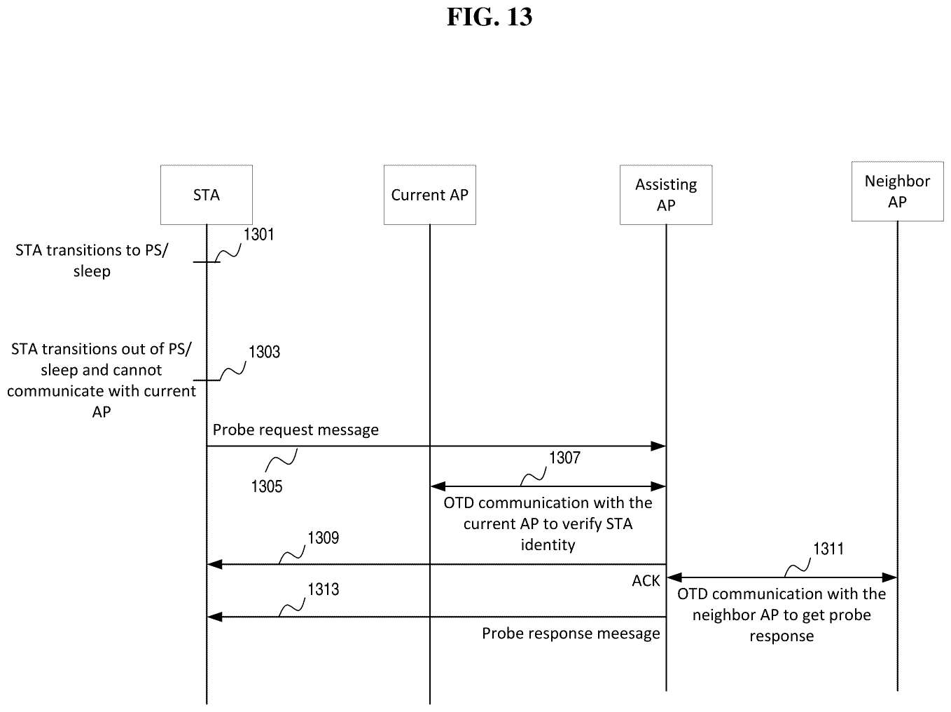

FIG. 13 illustrates a timeline for probing assistance via an assisting AP in accordance with an embodiment. In particular, FIG. 13 illustrates communication among a STA, a current AP, an assisting AP, and a target or neighbor AP. As illustrated, in operation 1301, the STA may transition into a power save (PS) mode or a sleep mode. In operation 1303, the STA may transition out of PS mode or sleep mode and the STA may determine that it is unable to communicate with the STA's current AP (e.g., low RSSI strength, among other factors). Accordingly, in operation 1305, the STA transmits to the assisting AP, a probe request message. In operation 1307, the assisting AP may perform OTD communication with the current AP to verity the STA identity. After verifying the STA identity, in operation 1309, the assisting AP may transmit to the STA an ACK message. In operation 1311, the assisting AP may perform OTD communication with the neighbor AP. Accordingly, in operation 1313, the assisting AP may transmit to the STA a probe response message that may include information regarding the neighbor AP. The information may include one or more of identification information of neighbor AP, an operating channel of the neighbor AP, context transfer information for the neighbor AP, among various other information.

In some embodiments, if a STA's location is known to the current AP, then the current AP can probe relevant APs that the STA can potentially roam to and provide probe responses of only those APs, or may provide probe responses of those APs first.

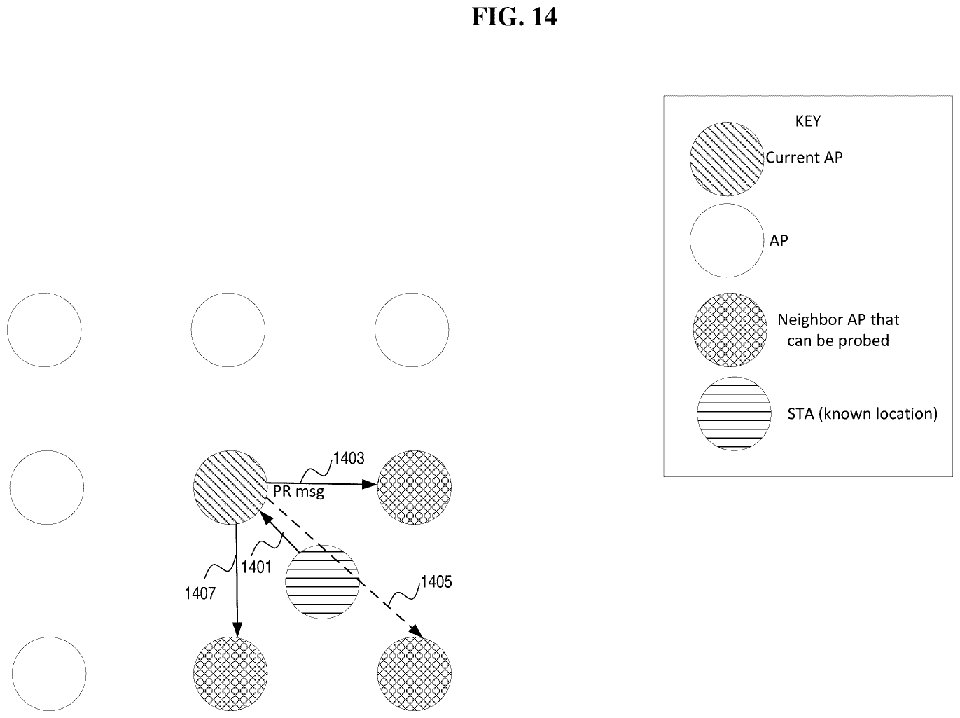

FIG. 14 illustrates a location-aware over-the-DS (OTD) probing in accordance with an embodiment. As illustrated, there is a current AP, a STA (known location), several neighbor APs that can be probed, and various other APs. In operation 1401, the STA transmits to the current AP, a probe request message. In some embodiments, the probe request message may request information on neighboring APs, including one or more of identification information, operating channel information, context transferability information among other information. Accordingly, in operations 1403, 1405 and 1407, the current AP performs OTD probing and communications with neighbor APs that can be probed based on the STA location in order to obtain probe response information to provide the STA. Accordingly, the current AP only probes three of the six APs that are illustrated as the location of the STA is known.

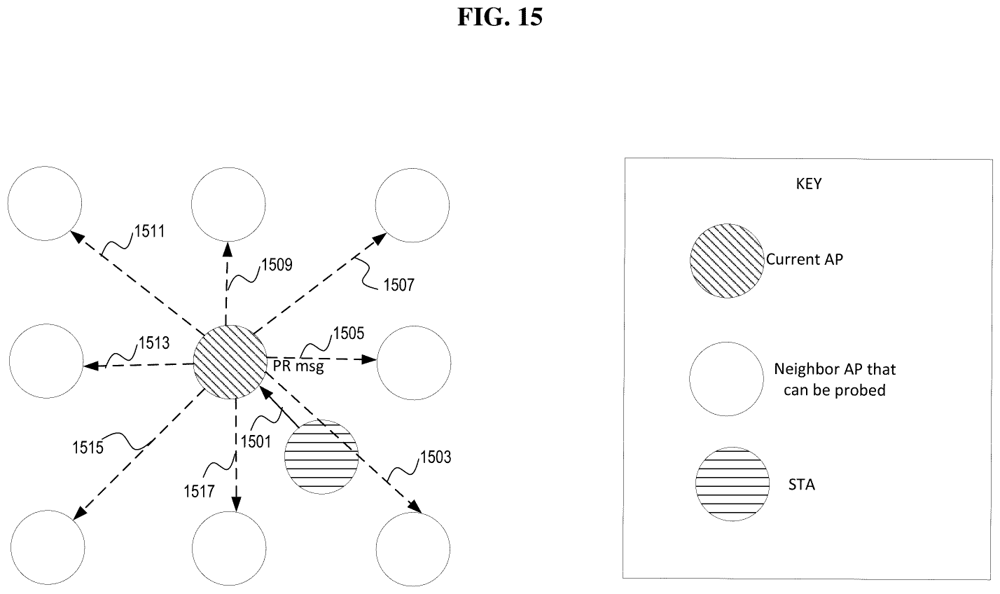

In some embodiments, if the STA's location is not known to the current AP, then the current AP can probe neighbor or relevant APs and provide probe responses of those APs to the STA. FIG. 15 illustrates a location unaware OTD probing in accordance with an embodiment. As illustrated, there is a current AP, a STA (location unknown), and several neighbor APs that can be probed. In operation 1501, the STA, whose location is unknown, transmits to the current AP, a probe request message. Accordingly, in operations 1503, 1505, 1507, 1509, 1511, 1513, 1515, and 1517, the current AP performs OTD probing, which includes communications with neighbor APs that can be probed, respectively, in order to obtain probe response information to provide the STA. Since the location of the STA is unknown, the current AP probes all of the illustrated APs, rather than a subset of the APs that are located within a threshold vicinity of the STA as illustrated in the example of FIG. 14.

In some embodiments, based on offset information provided by a current AP, a STA can switch to the channel of the neighbor AP closer to a time at which a beacon can arrive. In some embodiments, the offset information may include target beacon transmission times (TBTTs) information of a neighboring AP. In some embodiments, the offset information may indicate an offset of a beacon of a neighboring AP relative to the current AP, which may allow the STA to switch to the channel of the neighboring AP and minimize a wait time on the channel to procure a beacon. In some embodiments, the STA can stay on a neighboring AP channel for a duration that is sufficient to measure signal strength information (e.g, .RSSI) of the channel. This duration may be less than a duration of an entire beacon frame being transmitted by the neighboring AP. Accordingly, the STA may not be required to stay on the channel for the entire beacon frame's duration. Once an RSSI measurement is completed, the STA can switch back to the current AP's channel and continue with its communication.

In some embodiments, to prevent the STA from staying for an entire duration of the beacon for RSSI measurement, there can be a frame check sequence (FCS) inserted at a particular point in time (e.g., in the middle) of the beacon. Accordingly, the STA may only check until an FCS to get the RSSI measurement and then the STA may switch back to the current AP's channel.

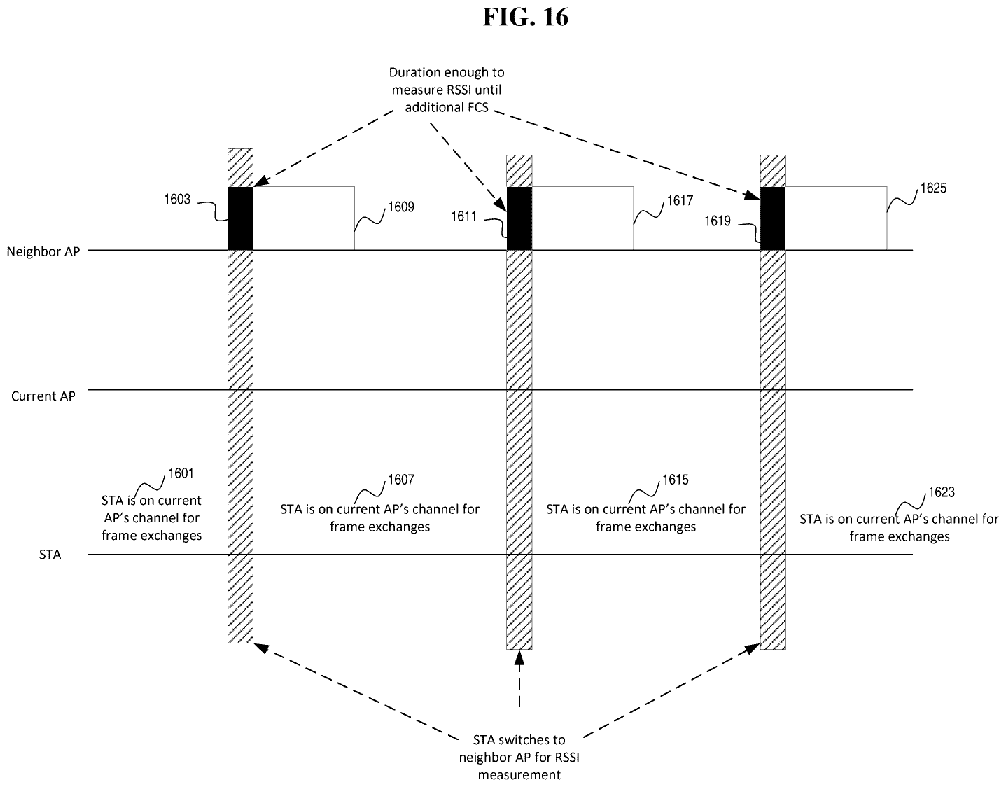

FIG. 16 illustrates an example of RSSI measurement in accordance with an embodiment. In particular, FIG. 16 illustrates a communication timeline among a neighbor AP, a current AP, and a STA. Initially, in operation 1601, the STA is operating on a current AP's channel for frame exchanges. During duration 1603, the STA switches the operating channel to a neighbor AP's channel for RSSI measurement. The STA may switch to the neighbor AP's channel at a time that is close to a beacon transmission time of a beacon frame 1609 being transmitted by the neighbor AP. The STA may receive offset information associated with the beacon transmission time of the neighbor AP from the current AP. The duration 1603 is sufficient enough to measure the RSSI until an additional FCS of a beacon frame 1609 of the neighbor AP. The duration 1603 may be a duration of time that is sufficient to measure an RSSI. In operation 1607, the STA switches the operating channel to the current AP's operating channel for frame exchanges. In operation 1611, the STA switches the operating channel to the neighbor AP's channel for RSSI measurement, where the duration of operation 1611 is enough to measure RSSI until additional FCS of beacon frame 1617 of neighbor AP. Again, in operation 1615, the STA switches the operating channel back to the current AP's channel for frame exchanges. In operation 1619, the STA switches the operating channel to the neighbor AP's channel for RSSI measurement. The duration of operation 1619 is sufficient enough to measure the RSSI until an additional FCS of a beacon frame 1625 of the neighbor AP. In operation 1623, the STA switches the operating channel back to the current AP's channel for frame exchanges.

In some embodiments, an AP that can provide probing assistance can advertise the AP's capability in one or more frames that the AP transmits. In some embodiments, the AP can include a capability bit in the AP's management frames such as beacons, probe responses, among others that can be set to a predetermined value (e.g., 1) to make the indication and to another predetermined value (e.g., 0) to indicate lack of such a support.

In some embodiments, a STA can seek a probing assistance may advertise the STA's requirement in one or more frames that the STA transmits. In some embodiments, the STA may include a requirement bit in the STA's management frame such as probe requests, (Re)association requests, among others that can be set to a predetermined value (e.g., 1) to make the indication and to another predetermined value (e.g., 0) to indicate lack of such a support.

Although several embodiments are described herein in the context of roaming, various embodiments in accordance with this disclosure may be applied to other applications including multi-AP coordination, among other applications. Embodiments in accordance with this disclosure may be used for single link and/or multi-link operation.

Embodiments in accordance with this disclosure provide roaming scanning procedures whereby a STA may transmit an intent to roam to one or more neighboring APs to a current AP associated with the STA. Accordingly, the current AP may communicate with the one or more neighboring APs to obtain neighboring AP information, including operating channel, context transferability, among other information, and to determine whether or not the neighboring APs can accommodate a roam request, and the current AP can provide the probe response information to the STA such that once the STA determines a need to roam, it can successfully roam to a neighboring AP that is willing and able to accommodate the STAs roaming request, thereby minimizing failed roaming attempts. Accordingly, embodiments in accordance with this disclosure may allow a STA to perform an enhanced scanning procedure, via an AP, with minimal disruption to ongoing data transmission, providing an improved user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of”′ preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit, to a first access point (AP) associated with the STA, a first frame including a request for information on one or more second APs that are not associated with the STA; and
receive, from the first AP, a second frame that includes the information on the one or more second APs.

2. The STA of claim 1, wherein the first frame is a basic service set (BSS) transition management query frame that requests the information on the one or more second APs that are neighbor APs of the first AP.

3. The STA of claim 1, wherein the first frame is a basic service set (BSS) transition management query frame that requests a recommendation for a candidate AP among the one or more second APs.

4. The STA of claim 1, wherein the processor is further configured to perform roaming from the first AP to a second AP based on the information on the one or more second APs.

5. The STA of claim 1, wherein the first frame includes a request for (i) information identifying the one or more second APs, or (ii) information indicating whether context established between the STA and the first AP is transferrable to the one or more second APs.

6. The STA of claim 1, wherein the second frame includes load information or queue length information for one or more access categories of the one or more second APs.

7. The STA of claim 1, wherein the second frame includes a plurality of information elements, each information element being associated with a respective one of the one or more second APs.

8. The STA of claim 1, wherein:
the first frame is a multi-link probe request frame that indicates a request for information on the one or more second APs that are neighbor APs of the first AP or belong to a seamless mobility domain (SMD); and
the second frame is a multi-link probe response frame that includes the information on the one or more second APs.

9. The STA of claim 8, wherein the multi-link probe request frame includes an SMD identifier that identifies the SMD to which the one or more second APs belong.

10. A first access point (AP) in a wireless network, the AP comprising:
a memory; and
a processor coupled to the memory, the processor configured to:
receive, from a station (STA) associated with the first AP, a first frame including a request for information on one or more second APs that are not associated with the STA;
communicate, with the one or more second APs, to obtain the information on the one or more second APs; and
transmit, to the STA, a second frame that includes the information on the one or more second APs.

11. The first AP of claim 10, wherein the first frame is a basic service set (BSS) transition management query frame that requests the information on the one or more second APs that are neighbor APs of the first AP.

12. The first AP of claim 10, wherein the first frame is a basic service set (BSS) transition management query frame that requests a recommendation for a candidate AP among the one or more second APs.

13. The first AP of claim 10, wherein the first frame includes a request for (i) information identifying the one or more second APs, or (ii) information indicating whether context established between the STA and the first AP is transferrable to the one or more second APs.

14. The first AP of claim 10, wherein the second frame includes load information or queue length information for one or more access categories of the one or more second APs.

15. The first AP of claim 10, wherein the second frame includes a plurality of information elements, each information element being associated with a respective one of the one or more second APs.

16. The first AP of claim 10, wherein:
the first frame is a multi-link probe request frame that indicates a request for information on the one or more second APs that are neighbor APs of the first AP or belong to a seamless mobility domain (SMD); and
the second frame is a multi-link probe response frame that includes the information on the one or more second APs.

17. A station (STA) in a wireless network, the STA comprising:
a memory; and
a processor coupled to the memory, the processor configured to:
receive, from a first access point (AP), an unsolicited frame that includes the information on one or more second APs; and
perform roaming based on the information on the one or more second Aps.

18. The STA of claim 17, wherein the frame includes load information or queue length information for one or more access categories of the one or more second APs.

19. The STA of claim 17, wherein the frame includes a plurality of information elements, each information element being associated with a respective one of the one or more second APs.

20. The STA of claim 17, wherein each of the one or more second APs operates on a respective operating channel that is different from an operating channel used for communication between the STA and the first AP.
